(19) United States
(12) Patent Application Publication
(10) Pub. No.: US 2024/0323045 A1
(43) Pub. Date: Sep. 26, 2024

(54) COMMUNICATION SYSTEM, COMMUNICATION DEVICE AND COMMUNICATION METHOD

(71) Applicant: Kioxia Corporation, Tokyo (JP)

(72) Inventors: Hirotaka HIGASHI, Kawasaki (JP); Manabu WATANABE, Kawasaki (JP); Junji WADATSUMI, Tokyo (JP)

(73) Assignee: Kioxia Corporation, Tokyo (JP)

(21) Appl. No.: 18/602,350

(22) Filed: Mar. 12, 2024

(30) Foreign Application Priority Data
Mar. 20, 2023 (JP) 2023-044370

(51) Int. Cl. H04L 12/40; H04L 1/00

(52) U.S. Cl. CPC H04L 12/4013; H04L 1/0007

(57) ABSTRACT

According to one embodiment, a communication system includes a host controller, communication devices, and a communication path which couples the host controller and the communication devices in a ring shape and configured to transfer a communication frame. The communication frame includes containers. Each of the communication devices includes a first circuit configured to insert and extract first data into and from at least one of the containers, a bus connected to the first circuit, and a second circuit coupled to the bus and configured to transmit and receive second data corresponding to the first data to and from the first circuit. The first data has a first data length which is a fixed length, and the second data has a second data length which is a unit of transfer of the second data and which is a variable length.

### CROSS-REFERENCE TO RELATED APPLICATION

This application is based upon and claims the benefit of priority from prior Japanese Patent Application No. 2023-044370, filed Mar. 20, 2023, the entire contents of which are incorporated herein by reference.

### FIELD

An embodiment described herein relates generally to a communication system, a communication device and a communication method.

### BACKGROUND

In a communication system including a host controller and a plurality of communication devices, a coupling method of coupling the host controller and the communication devices in a ring shape is known.

### BRIEF DESCRIPTION OF THE DRAWINGS

FIG. 1 is a block diagram showing an overall configuration of a communication system according to an embodiment.

FIG. 2 is a block diagram of a communication device included in the communication system according to the embodiment.

FIG. 3 is a diagram showing an example of a communication frame in the communication system according to the embodiment.

FIG. 4 is a diagram showing an example of transmission of a communication frame in ring coupling of the communication system according to the embodiment.

FIG. 5 is a flowchart showing a procedure for extracting data from a container of a communication frame in the communication system according to the embodiment.

FIG. 6 is a diagram showing a specific example of dividing data extracted from a container of a communication frame in the communication system according to the embodiment.

FIG. 7 shows a specific example of integrating data extracted from containers of a plurality of communication frames in the communication system according to the embodiment.

FIG. 8 is a flowchart showing a procedure for inserting data into a container of a communication frame in the communication system according to the embodiment.

FIG. 9 is a diagram showing a specific example of integrating data of a plurality of packets and inserting the integrated data into a container of a communication frame in the communication system according to the embodiment.

FIG. 10 is a diagram showing a specific example of dividing data of a packet into data items and inserting the data items into containers of different communication frames in the communication system according to the embodiment.

### DETAILED DESCRIPTION

According to one embodiment, a communication system includes a host controller, a plurality of communication devices, and a communication path which couples the host controller and the communication devices in a ring shape and configured to transfer a communication frame of a serial signal. The communication frame includes a plurality of containers. Each of the communication devices includes a first circuit configured to insert and extract first data into and from at least one of the containers, a bus connected to the first circuit, and a second circuit coupled to the bus and configured to transmit and receive second data corresponding to the first data to and from the first circuit via the bus. The first data has a first data length which is a fixed length, and the second data has a second data length which is a unit of transfer of the second data and which is a variable length.

An embodiment will be described below with reference to the drawings. A plurality of structural elements having substantially the same function and configuration in one embodiment or different embodiments are distinguished from each other. Numerals or letters may be added to the ends of the reference numerals of the structural elements. In embodiments subsequent to an embodiment, different points will mainly be described. All descriptions of one embodiment also apply as descriptions of another embodiment unless they are excluded explicitly or self-evidently.

### 1. Configuration

A communication system according to an embodiment will be described below.

### 1.1 Configuration of Communication System

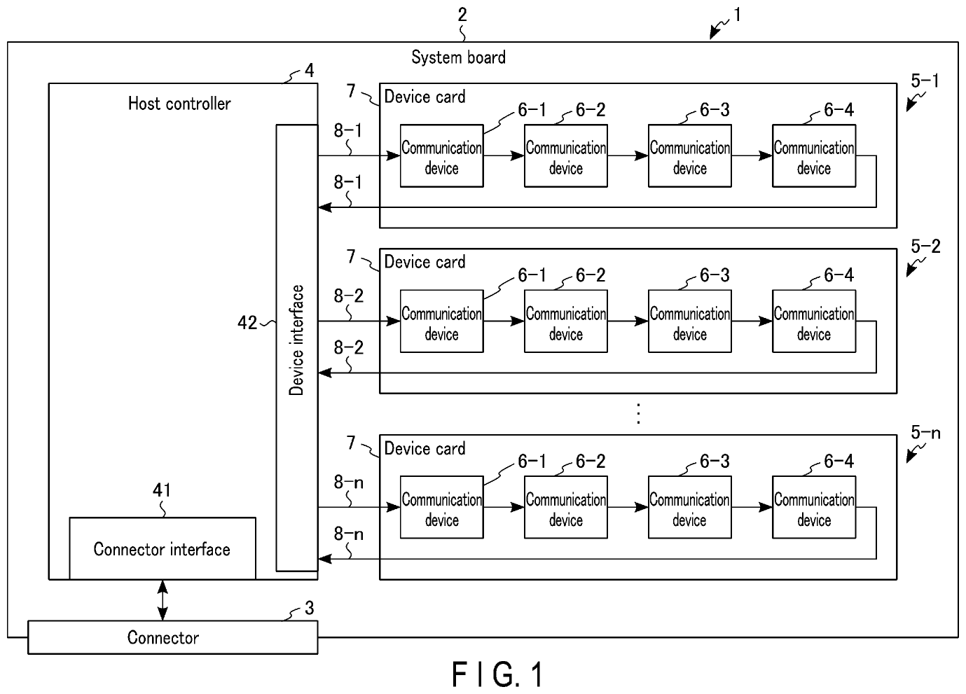

An example of a configuration of a communication system 1 will be described with reference to FIG. 1. FIG. 1 is a block diagram showing an overall configuration of the communication system 1.

As shown in FIG. 1, the communication system 1 includes a system board 2, a connector 3, a host controller 4, a plurality of device cards 5, and a plurality of communication paths 8. In the example of FIG. 1, the communication system 1 includes n device cards 5-1 to 5-n where n is an integer equal to or greater than 1. The communication system 1 also includes n communication paths 8-1 to 8-n corresponding to their respective n device cards 5-1 to 5-n.

The system board 2 is, for example, an accelerator board that is provided for an ultrawide band (for example, 200 GB/s or more) and a large capacity.

The connector 3 is provided on the system board 2. The connector 3 is used for wired coupling between the system board 2 and an external device such as a computer. The connector 3 is coupled to the host controller 4. Note that the system board 2 may include a communication circuit in addition to the connector 3. The communication circuit is used for wireless coupling between the system board 2 and an external device.

The host controller 4 controls the communication system 1 in its entirety. The host controller 4 controls communication devices 6 implemented on each of the device cards 5. If each communication device 6 is, for example, a memory device, the host controller 4 requests (instructs) the communication device 6 to perform a data write operation, a data read operation, or the like. That is, if each communication device 6 is a memory device, the communication system 1 may also be referred to as a memory system. The host controller 4 includes a connector interface circuit 41 and a device interface circuit 42.

The connector interface circuit 41 transmits and receives information to and from an external device via the connector 3.

The device interface circuit 42 transmits and receives information to and from the device card 5 via the communication path 8. For example, the device interface circuit 42 is configured to transmit and receive differential serial signals.

Each of the device cards 5 includes a substrate 7 and a plurality of communication devices 6. In the example of FIG. 1, each of the device cards 5 includes four communication devices 6-1 to 6-4. The communication devices 6-1 to 6-4 are implemented on the substrate 7 by solder, a socket, or the like. For example, the communication devices 6-1 to 6-4 may be arranged side by side along the longitudinal direction of substrate 7.

The communication devices 6 operate on the basis of communication with the host controller 4. Below is a description of a case where each of the communication devices 6 is a memory device with a NAND flash memory thereon. For example, each communication device 6 may be a memory system such as a solid state drive (SSD) with a NAND flash memory thereon. Note that if the communication devices 6 are memory devices, the device cards 5 may also be referred to as memory cards. The communication devices 6 are communicatively coupled to the device interface circuit 42 via the communication paths 8.

The communication paths 8-1 to 8-n correspond to the device cards 5-1 to 5-n, respectively. Each of the communication paths 8 couples, in a ring shape, the device interface circuit 42 to communication devices 6-1 to 6-4 included in the corresponding device card 5. More specifically, a data output terminal of the device interface circuit 42, communication devices 6-1, 6-2, 6-3 and 6-4, and a data input terminal of the device interface circuit 42 are coupled in a ring shape via the communication path 8. The communication paths 8 can transmit differential serial signals.

The communication devices 6 of one device card 5 transmit and receive a communication frame of differential serial signals via the communication path 8. The communication frame is a unit of data to be transmitted via the communication path 8. In the case of ring coupling, the communication frame output from the host controller 4 is input to the host controller 4 via the communication devices 6-1, 6-2, 6-3 and 6-4. The communication frame includes a plurality of containers. A container length indicating the length (or size) of each of the containers is fixed. That is, the data length indicating the length (or size) of data (information) contained in one container is fixed. Each of the communication devices 6 inserts and extracts data into and from containers of a communication frame in accordance with a condition. Data insertion and extraction includes inserting (writing) data into a container and extracting (reading) data from a container. For example, a communication frame may include a number of containers according to a band to be required and a band of each communication device 6.

Note that the communication system 1 may be configured to exclude the system board 2. In addition, the connector interface circuit 41 may be directly coupled to an external device without using the connector 3. The system board 2 and the substrate 7 may be formed integrally as one unit.

### 1.2 Configuration of Communication Devices

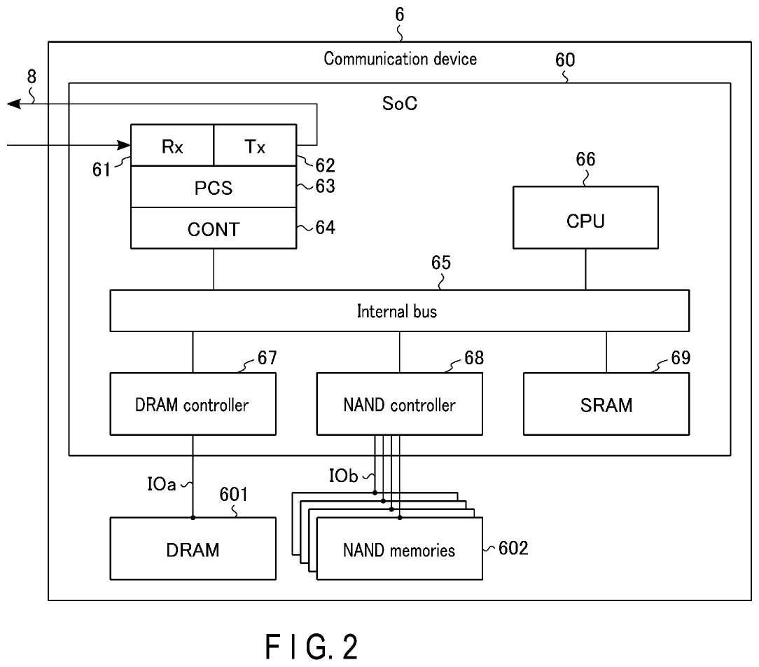

The configuration of the communication device 6 will be described below with reference to FIG. 2. FIG. 2 is a block diagram of the communication device 6. In the example of FIG. 2, the communication device 6 is a memory device that is equipped with a NAND flash memory as a nonvolatile memory.

As shown in FIG. 2, the communication device 6 includes a system on chip (SoC) 60, a dynamic random access memory (DRAM) 601 and a plurality of NAND flash memories 602. Hereinafter, the NAND type flash memories 602 will also be referred to simply as NAND memories 602.

The SoC 60 is a device system that operates in response to a request from the host controller 4. The SoC 60 controls the DRAM 601 and NAND memories 602. For example, the SoC 60 instructs the NAND memories 602 to perform a read operation, a write operation, and the like. The SoC 60 includes a reception unit (also referred to as Rx hereinafter) 61, a transmission unit (also referred to as Tx hereinafter) 62, a protocol conversion unit (also referred to as PCS hereinafter) 63, a communication control circuit (also referred to as CONT hereinafter) 64, an internal bus 65, a central processing unit (CPU) 66, a DRAM controller 67, a NAND controller 68, and a static random access memory (SRAM) 69. The SoC 60 is configured as a circuit device including these components.

The configuration including the reception unit 61, transmission unit 62, protocol conversion unit 63 and communication control circuit 64 functions as an interface circuit that controls transmission and reception of data between the host controller 4 and the communication device 6. The communication control circuit 64, CPU 66, DRAM controller 67, NAND controller 68 and SRAM 69 are coupled to each other via an internal bus 65.

The reception unit 61 is a reception circuit. The reception unit 61 corresponds to a physical layer. The reception unit 61 is coupled to the communication path 8 and the protocol conversion unit 63. The reception unit 61 receives a communication frame from the host controller 4 or the communication device 6 in the preceding stage via the communication path 8. The reception unit 61 performs a physical process such as waveform equalization of the received communication frame and supplies it to the protocol conversion unit 63.

The transmission unit 62 is a transmission circuit. The transmission unit 62 corresponds to a physical layer. The transmission unit 62 is coupled to the communication path 8 and the protocol conversion unit 63. The transmission unit 62 performs a physical process such as waveform equalization of the communication frame supplied from the protocol conversion unit 63. The transmission unit 62 transmits the communication frame to the communication path 8 toward the host controller 4 or the communication device 6 in the subsequent stage.

The protocol conversion unit 63 performs protocol conversion of a communication frame. The protocol conversion unit 63 corresponds to a link layer. The protocol conversion unit 63 is coupled to the communication control circuit 64. For example, the protocol conversion unit 63 converts the communication frame received from the reception unit 61 into a protocol in accordance with a protocol in an upper hierarchy. In other words, the protocol conversion unit 63 converts the communication frame received from the reception unit 61 into a protocol in accordance with the bus protocol of the internal bus 65. The upper hierarchy is a hierarchy that is higher than the link layer when the structure of a communication layer in communications between the host controller 4 and the communication device 6 is roughly divided. For example, the internal bus 65 and each of the circuits (the CPU 66, DRAM controller 67, NAND controller 68, SRAM 69, DRAM 601 and NAND memory 602) coupled to the communication control circuit 64 via the internal bus 65 corresponds to the upper hierarchy. The protocol conversion unit 63 transmits the communication frame, which is converted into the protocol in accordance with the upper hierarchy, to the communication control circuit 64.

The protocol conversion unit 63 converts the communication frame received from the communication control circuit 64 into a protocol in accordance with a protocol of the lower hierarchy. In other words, the protocol conversion unit 63 converts the communication frame received from the communication control circuit 64 into a protocol in accordance with a protocol corresponding to the communication path 8. The lower hierarchy is a hierarchy that is lower than the physical layer when the structure of the communication layer is roughly divided. The protocol conversion unit 63 transmits a communication frame, which is converted into the protocol in accordance with the lower hierarchy, to the transmission unit 62.

The communication control circuit 64 inserts and extracts data into and from a container corresponding to the communication device of a communication frame. The communication control circuit 64 corresponds to a link layer. For example, the communication control circuit 64 extracts data (information) from a container corresponding to the communication device of the communication frame received from the protocol conversion unit 63. Also, the communication control circuit 64 inserts data (information) of a packet in an upper hierarchy into an empty container of the communication frame. The packet is a transmission unit of data transferred between the communication control circuit 64 and the upper hierarchy in accordance with an operation to be executed in the upper hierarchy (write operation, read operation, or the like). The upper hierarchy includes a plurality of devices coupled via the internal bus 65.

The communication control circuit 64 compares the container length of the container with a packet length of the packet. Based on the comparison result, the communication control circuit 64 divides or integrates data contained in the container or packet.

The container length is a length of each of the containers included in the communication frame. More specifically, the container length is proportional to a container payload length of a container payload contained in the container. The container payload will be described later. In other words, the container length is proportional to a data length of data contained in the container (container payload) of the communication frame.

The packet length is based on the system specifications of the upper hierarchy. For example, the packet length may be set based on the bus protocol of the internal bus 65. The packet length is proportional to a data length of data included in a packet transmitted and received (transferred) between the communication control circuit 64 and the internal bus 65, in accordance with an operation to be performed in the upper hierarchy. The packet length is variable. For example, the packet length (data length of data to be transferred) varies depending on the operation to be performed in the upper hierarchy.

More specifically, for example, if a write operation is performed in the NAND memory 602 of the upper hierarchy, the packet transmitted from the communication control circuit 64 to the upper hierarchy includes write data, commands, and addresses. If a read operation is executed in the NAND memory 602 of the upper hierarchy, the packet transmitted from the communication control circuit 64 to the upper hierarchy includes commands and addresses. If read data read from the NAND memory 602 is transmitted to the lower hierarchy, the packet transmitted from the upper hierarchy to the communication control circuit 64 includes read data. The data length of the read data may differ from that of write data. Thus, the packet length of a packet transmitted from the communication control circuit 64 to the upper hierarchy during the write operation, the packet length of a packet transmitted from the communication control circuit 64 to the upper hierarchy during the read operation, and the packet length of a packet transmitted from the upper hierarchy to the communication control circuit 64 during read operation are different. Thus, the packet length (data length) is varied according to the operation executed in the upper hierarchy.

When data is extracted from the container of a communication frame in a lower hierarchy, if the container length is more than the packet length, the communication control circuit 64 divides the extracted data. Then, the communication control circuit 64 transmits the divided data (also referred to as divided container data) to the upper hierarchy as separate packets. On the other hand, when data is extracted from a plurality of containers, if the length of each of the containers is less than the packet length, the communication control circuit 64 integrates the data extracted from the containers. Then, the communication control circuit 64 transmits the integrated data (also referred to as integrated container data) to the upper hierarchy as one packet.

When the communication control circuit 64 receives data of a plurality of packets from the upper hierarchy, if the container length is more than the packet length, the communication control circuit 64 integrates the data of the packets. Then, the communication control circuit 64 inserts the integrated data (also referred to as integrated packet data) into one container. On the other hand, when the communication control circuit 64 receives data of a packet from the upper hierarchy, if the container length is less than the packet length, the communication control circuit 64 divides the data of the packet. Then, the communication control circuit 64 inserts the divided data (also referred to as divided packet data) into a plurality of containers separately.

The communication control circuit 64 neither divides nor integrates the received data if the container length and the packet length are the same.

The CPU 66 is a processor. The CPU 66 controls the operation of the communication device 6 in its entirety based on the request of the host controller 4. The CPU 66 controls the DRAM controller 67, NAND controller 68 and SRAM 69 via the internal bus 65. For example, the CPU 66 instructs the NAND controller 68 to perform a write operation, a read operation, or the like for the NAND memory 602.

The DRAM controller 67 controls the DRAM 601 based on the request of the CPU 66. The DRAM controller 67 transmits and receives data to and from the DRAM 601 via a signal line IOa.

The DRAM 601 is a volatile memory. Note that the DRAM 601 may be another volatile memory. The DRAM 601 temporarily stores data which the SoC 60 has read from the NAND memory 602 and write data which the SoC 60 has received from the host controller 4. Note that the DRAM 601 may be implemented on the SoC 60.

The NAND controller 68 controls the NAND memory 602. One NAND controller 68 may control a plurality of NAND memories 602. The NAND controller 68 transmits and receives data to and from the NAND memories 602 via signal lines IOb. For example, the NAND controller 68 transmits data (command, address, data, etc.) corresponding to a write operation, a read operation or an erase operation to the NAND memories 602. The NAND controller 68 also receives read data from the NAND memories 602 during the read operation.

The NAND memories 602 are nonvolatile storage mediums. The NAND memories 602 may be nonvolatile storage mediums other than the NAND flash memory. The NAND memories 602 nonvolatilely store data received from the NAND controller 68. The NAND memory 602 also reads the nonvolatilely stored data and transmits it to the NAND controller 68.

The SRAM 69 is a volatile memory. Note that the SRAM 69 may be another volatile memory. The SRAM 69 can be used as a work area of the CPU 66.

### 1.3 Configuration of Communication Frame

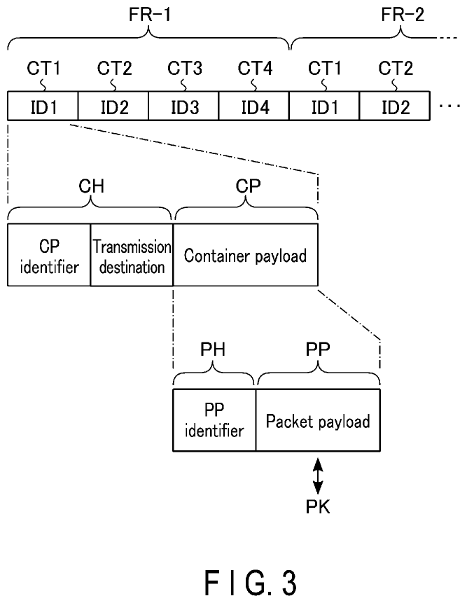

An example of a configuration of the communication frames will be described with reference to FIG. 3. FIG. 3 is a diagram showing an example of the communication frames. In the following descriptions, identification information items of the host controller 4 and communication devices 6-1, 6-2, 6-3 and 6-4 are denoted as ID0, ID1, ID2, ID3 and ID4, respectively.

As shown in FIG. 3, the host controller 4 transmits a plurality of communication frames FR in sequence. For example, each of the communication frames FR includes a plurality of containers CT of the same fixed length. In the example of FIG. 3, a communication frame FR-1 includes four containers CT1 to CT4 of the same fixed length. The containers CT store data (information) that can be inserted and extracted into and from the communication device 6. The same applies to a communication frame FR-2 and its subsequent frames.

Each of the containers CT may store data corresponding to the host controller 4 or any communication device 6. In the example of FIG. 3, the container CT1 stores identification information ID1, that is, data corresponding to the communication device 6-1. The container CT2 stores identification information ID2, that is, data corresponding to the communication device 6-2. The container CT3 stores identification information ID3, that is, data corresponding to the communication device 6-3. The container CT4 stores identification information ID4, that is, data corresponding to the communication device 6-4. Note that the data stored in each of the containers CT is optional. The container CT1 may store identification information ID0, that is, data corresponding to the host controller 4 or data corresponding to any of the identification information ID2 to ID4. In addition, the containers CT1 to CT4 may store data corresponding to the identification information ID1.

The containers CT each include a container header CH and a container payload CP. The container header CH includes a CP identifier and transmission destination information. Note that the container header CH may include transmission source information. The CP identifier is an identifier that identifies the start and end of the container payload CP. The transmission destination information includes identification information ID of the communication device 6 or the host controller 4 as a transmission destination. If the transmission destination is, for example, the communication device 6-1, the transmission destination information includes information regarding the identification information ID1.

The container payload CP includes data transmitted and received (transferred) between the lower hierarchy and the upper hierarchy. The data length of data included in the container payload CP is fixed. The container payload CP includes a packet header PH and one or more packet payloads PP. For example, the container payload CP may include a plurality of packet payloads PP in accordance with data division or data integration in the communication control circuit 64.

The packet header PH includes a PP identifier. The PP identifier is an identifier that identifies the start and end of the packet payload PP. The packet header PH may also include information regarding data division or data integration.

The packet payload PP includes data (information) corresponding to an operation to be performed in the upper hierarchy. In other words, the packet payload PP includes data of a packet PK of the upper hierarchy. For example, the packet payload PP may include transmission destination information (address), attribute information (command) of an operation (read operation, write operation, etc.) to be performed in the upper hierarchy, data (write data, read data, etc.), information of the packet length, and the like. For example, if a write operation is performed in the NAND memory 602, the packet payload PP transmitted from the lower hierarchy to the upper hierarchy includes a write command, an address, and write data. For example, if a read operation is performed in the NAND memory 602, the packet payload PP transmitted from the upper hierarchy to the lower hierarchy includes read data.

The communication control circuit 64 may divide or integrate data based on the information of the packet header PH. In other words, the communication control circuit 64 may divide or integrate the packet payload PP based on the information of the packet header PH.

### 2. Example of Transmission of Communication Frames in Ring Coupling

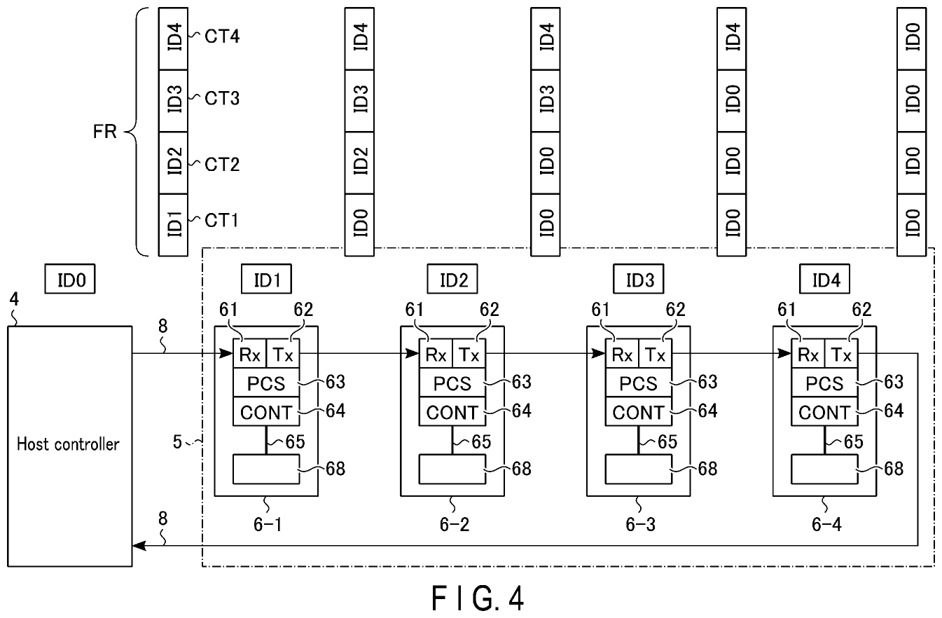

An example of transmission of the communication frames FR in ring coupling will be described below with reference to FIG. 4. FIG. 4 is a diagram showing an example of transmission of the communication frames FR in the ring coupling. FIG. 4 also shows a host controller 4 and a single device card 5 connected to the host controller 4. In the example of FIG. 4, neither data division nor data integration is performed. For simplicity of description, FIG. 4 shows a NAND controller 68 connected to the internal bus 65 and does not show other circuits or configurations.

As shown in FIG. 4, for example, the host controller 4 transmits to the communication device 6-1 a communication frame FR whose container CT1 stores data corresponding to identification information ID1 (communication device 6-1), whose container CT2 stores data corresponding to identification information ID2 (communication device 6-2), whose container CT3 stores data corresponding to identification information ID3 (communication device 6-3), and whose container CT4 stores data corresponding to identification information ID4 (communication device 6-4).

Data is extracted from the container CT1 in the communication device 6-1. More specifically, the communication control circuit 64 of the communication device 6-1 performs the following operation. The communication control circuit 64 confirms the transmission destination information of the container header CH of each of the containers CT. If the communication control circuit 64 confirms that the container header CH of the container CT1 includes the identification information ID1 of the communication device 6-1 as transmission destination information, it extracts data from the container payload CP (packet payload PP) of the container CT1. The communication control circuit 64 transmits the extracted data to an upper hierarchy as a packet PK. If the extracted data (packet PK) includes, for example, a write operation requesting command, an address, and write data, the CPU 66 controls the NAND controller 68 to perform a write operation to the NAND memory 602.

If for example the communication device 6-1 includes data (packet PK data) to be inserted into the container CT1, the communication control circuit 64 converts the transmission destination information of the container header CH of the container CT1 from the identification information IDI of the communication device 6-1 into the identification information ID0 of the host controller 4. Then, the communication control circuit 64 inserts data to be transmitted to the host controller 4 into the container payload CP (packet payload PP) of the container CT1 to update the communication frame FR. For example, if data to be inserted is read data corresponding to a read operation requesting command included in the already-received communication frame FR, the communication control circuit 64 inserts data read from the NAND memory 602 into the container payload CP of the container CT1. That is, data corresponding to the identification information ID0 is inserted into the container CT1. If there is no data (packet PK) to be inserted into the container CT, the communication control circuit 64 erases data of the container header CH and container payload CP of the container CT to make the container CT empty (null) and updates the communication frame FR. The communication device 6-1 transmits the updated communication frame FR to the communication device 6-2.

As in the communication device 6-1, in the communication device 6-2, data is inserted into and extracted from the container CT2. Accordingly, data corresponding to the identification information ID2 is extracted from the container CT2. Then, data corresponding to the identification information ID0 is inserted into the container CT2, for example. The communication device 6-2 transmits the updated communication frame FR to the communication device 6-3.

As in the communication device 6-1, in the communication device 6-3, data is inserted into and extracted from the container CT3. Accordingly, data corresponding to the identification information ID3 is extracted from the container CT3. Then, data corresponding to the identification information ID0 is inserted into the container CT3, for example. The communication device 6-3 transmits the updated communication frame FR to the communication device 6-4.

As in the communication device 6-1, in the communication device 6-4, data is inserted into and extracted from the container CT4. Accordingly, data corresponding to the identification information ID4 is extracted from the container CT4. Then, data corresponding to the identification information ID0 is inserted into the container CT4, for example. The communication device 6-4 transmits the updated communication frame FR to the host controller 4.

### 3. Extraction of Data from Containers of Communication Frames

Next is a description of extraction of data from the container CT of the communication frame FR.

### 3.1 Flow of Procedure for Extracting Data from Container of Communication Frame

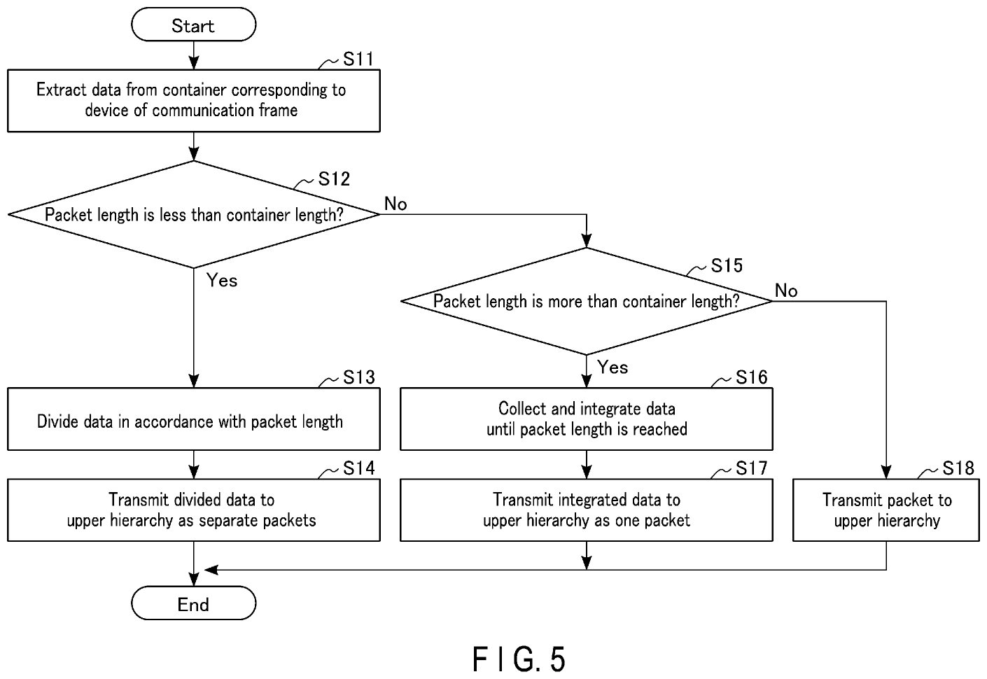

A flow of a procedure for extracting data from the container CT of a communication frame FR will be described with reference to FIG. 5. FIG. 5 is a flowchart showing a procedure for extracting data from the container CT of the communication frame FR.

As shown in FIG. 5, first, the communication device 6 extracts data from the container CT, which corresponds to the device 6, of a communication frame FR (S11). More specifically, the reception unit 61 transmits the received communication frame FR to the protocol conversion unit 63. The protocol conversion unit 63 executes protocol conversion, which corresponds to the upper hierarchy (bus protocol of the internal bus 65), to the communication frame FR. The protocol conversion unit 63 transmits the communication frame FR, which is subjected to the protocol conversion, to the communication control circuit 64. The communication control circuit 64 confirms the container header CH of each container CT and extracts data of the container payload CP from the container CT corresponding to the communication device 6. In addition, the communication control circuit 64 refers to the packet header PH to extract data of the packet payload PP from the container payload CP.

The communication control circuit 64 compares the packet length and the container length (S12). For example, the communication control circuit 64 refers to the packet header PH to compare the packet length and the container length (container payload length).

If the packet length is less than the container length (Yes in S12), the communication control circuit 64 divides the data extracted from the packet payload PP into divided data items in accordance with the packet length (S13). In other words, the communication control circuit 64 generates a plurality of packet payloads PP into which data is divided.

The communication control circuit 64 transmits the divided data items (divided container data items) to the upper hierarchy as separate packets PK (S14). More specifically, the communication control circuit 64 generates a plurality of packets PK corresponding to their respective divided data items. For example, if the two divided data items correspond to different write operations, each of the packets PK includes write data, a command, and an address. The communication control circuit 64 transmits two packets PK separately to the upper hierarchy. For example, the communication control circuit 64 transmits two packets PK to separate circuits (two of the CPUs 66, DRAM controller 67, NAND controller 68 and SRAM 69) in the upper hierarchy. Alternatively, the communication control circuit 64 time-divides the two packets PK and transmits the time-divided packets to the same circuit (one of the CPU 66, DRAM controller 67, NAND controller 68 and SRAM 69) in the upper hierarchy.

If the packet length is more than the container length (No in S12 and Yes in S15), the communication control circuit 64 collects and integrates data of a plurality of containers CT (packet payload PP) until the data length of the extracted data reaches the packet length (S16). That is, the communication control circuit 64 integrates data of a plurality of container CT (packet payload PP).

The communication control circuit 64 transmits the integrated data (integrated container data) to the upper hierarchy as one packet PK (S17). More specifically, the communication control circuit 64 generates one packet PK corresponding to the integrated data. For example, if the integrated data corresponds to a single write operation, the packet PK includes write data, a command and an address. The communication control circuit 64 transmits the packet PK to the upper hierarchy.

If the packet length and the container length are the same (No in S12 and No in S15), the communication control circuit 64 transmits the data of the packet payload PP to the upper hierarchy as one packet PK (S18).

### 3.2 Specific Example of Dividing Data Extracted from Container of Communication Frame

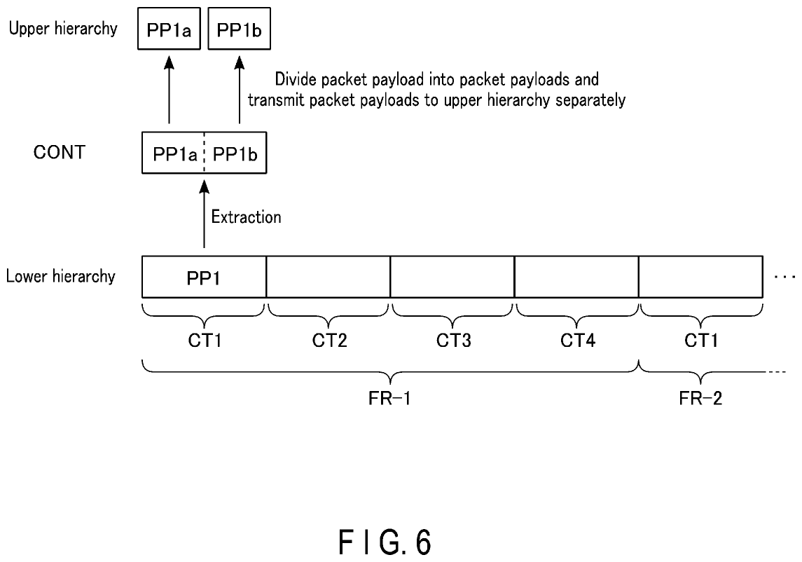

A specific example of dividing data extracted from the container CT of the communication frame FR will be described with reference to FIG. 6. FIG. 6 is a diagram showing a specific example of dividing data extracted from the container CT of the communication frame FR. In the example of FIG. 6, the communication device 6-1 divides data of the container CT1 of the communication frame FR-1. In FIG. 6, the packet payload PP of a target container CT (container CT1 of the communication frame FR-1) is shown to simplify the description and the other containers CT are not shown.

As shown in FIG. 6, the communication frame FR-1 of the lower hierarchy includes four containers CT1 to CT4. For example, the container CT1 of the communication frame FR-1 includes data of a packet payload PP1. For example, the communication control circuit 64 (CONT) of the communication device 6-1 extracts data of the packet payload PPI from the container payload CP of the container CT1. The communication control circuit 64 refers to the packet header PH to compare the packet length and the container length. If the packet length is, for example, 1/2 times the container length, the communication control circuit 64 divides the data of the packet payload PPI into two data items. In other words, the communication control circuit 64 divides the packet payload PPI into two packet payloads. Hereinafter, the two divided packet payloads will be referred to as packet payloads PP1a and PP1b. The communication control circuit 64 transmits data of the packet payload PP1a and data of the packet payload PP1b separately to the upper hierarchy. That is, the communication control circuit 64 transmits a packet PK including the data of the packet payload PP1a and a packet PK including the data of the packet payload PP1b separately to the upper hierarchy.

In the example of FIG. 6, the communication control circuit 64 of the communication device 6-1 divides data of one packet payload PP based on the packet length; however, the embodiment is not limited to this example. For example, the host controller 4 may insert two packet payloads PP to be divided by the communication device 6 into the container payload CP of one container CT in advance. That is, the host controller 4 may control the division of data. In the example of FIG. 6, the container CT1 includes packet payloads PP1a and PP1b in advance. In this case, the communication control circuit 64 can divide data for each packet payload PP based on he number of packet payloads PP included in the container payload CP of the container CT1.

### 3.3 Specific Examples of Integrating Data Extracted from Containers of Communication Frames

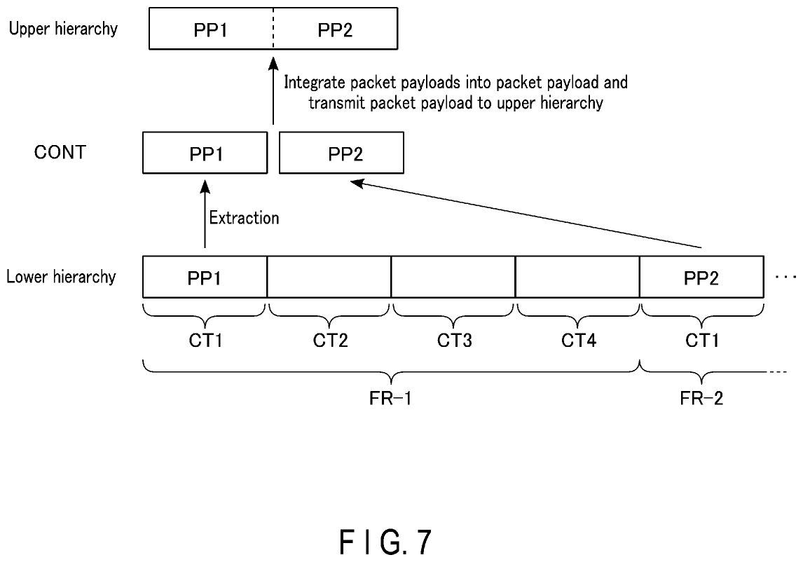

A specific example of integrating data extracted from the containers CT of a plurality of communication frames FR will be described below with reference to FIG. 7. FIG. 7 is a diagram showing a specific example of integrating data extracted from the containers CT of a plurality of communication frames FR. In the example of FIG. 7, the communication device 6-1 integrates the container CT1 of the communication frame FR-1 and the container CT1 of the communication frame FR-2. In FIG. 7, the packet payload PP of a target container CT (the container CT1 of the communication frame FR-1 and the container CT1 of the communication frame FR-2) is shown to simplify the description and the other containers CT are not shown.

As shown in FIG. 7, the communication frame FR-1 of the lower hierarchy includes four containers CT1 to CT4. For example, the container CT1 of the communication frame FR-1 includes data of the packet payload PP1. Similarly, the container CT1 of the communication frame FR-2 includes data of a packet payload PP2. For example, the communication control circuit 64 (CONT) of the communication device 6-1 extracts data of the packet payload PP1 from the container payload CP of the container CT1 of the communication frame FR-1. The communication control circuit 64 refers to the packet header PH to compare the packet length and the container length. If the packet length is, for example, twice the container length, the communication control circuit 64 further extracts data of the packet payload PP2 from the container payload CP of the container CT1 of the communication frame FR-2. The communication control circuit 64 integrates the data of the packet payload PP1 and the data of the packet payload PP2. In other words, the communication control circuit 64 integrates the packet payload PP1 and the packet payload PP2. The communication control circuit 64 transmits a packet PK containing the integrated data (integrated container data) to the upper hierarchy.

### 4. Insertion of Data into Containers of Communication Frames

Next is a description of inserting data into the container CT of the communication frame FR.

### 4.1 Flow of Procedure for Inserting Data into Container of Communication Frame

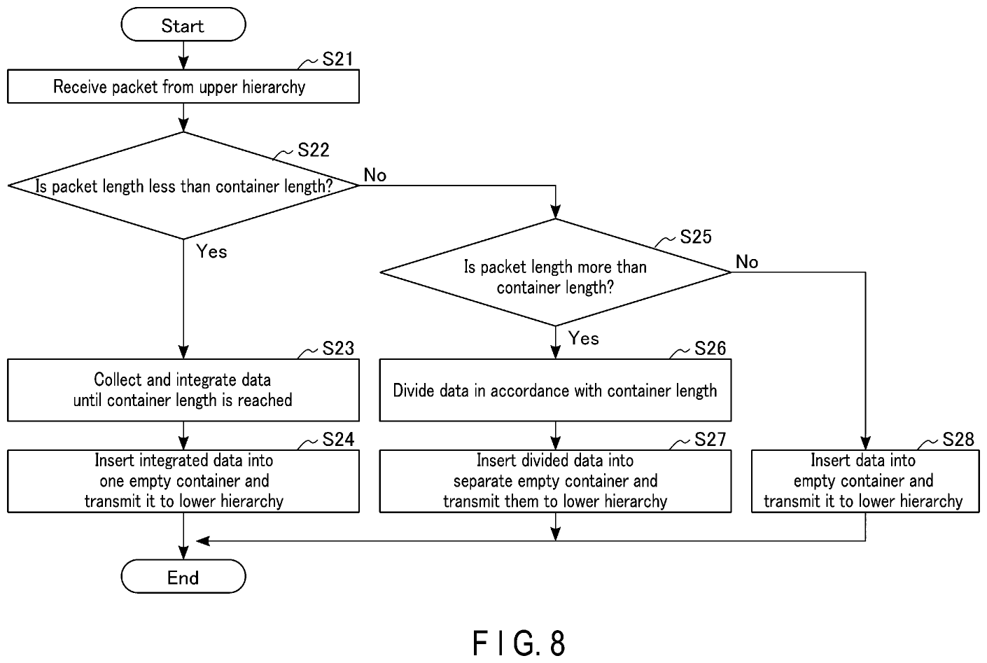

The flow of a procedure for inserting data into the container CT of the communication frame FR will be described with reference to FIG. 8. FIG. 8 is a flowchart of a procedure for inserting data into the container CT of the communication frame FR.

As shown in FIG. 8, the communication control circuit 64 receives a packet PK from the upper hierarchy (S21). That is, the communication control circuit 64 receives data to be inserted into the container CT of the communication frame FR from the upper hierarchy.

The communication control circuit 64 compares the packet length and the container length (S22). More specifically, for example, the communication control circuit 64 confirms the packet length of the packet received from the upper hierarchy. Then, the communication control circuit 64 compares the packet length and the container length.

If the packet length is less than the container length (Yes in S22), the communication control circuit 64 collects data of a plurality of packets PK and integrates them until the data length of the data received from the upper hierarchy reaches the container length (S23). In other words, the communication control circuit 64 collects a plurality of packets PK and integrates them until the container length is reached.

The communication control circuit 64 inserts the integrated data (integrated packet data) into one empty container CT of the communication frame FR and transmits it to the lower hierarchy (S24). More specifically, the communication control circuit 64 inserts a packet payload PP including the integrated data and its corresponding packet header PH into the container payload CP of the empty container CT. The packet header PH may include information indicating the integrated data. In addition, the communication control circuit 64 updates the container header CH of the empty container CT. The communication control circuit 64 transmits the communication frame FR including the updated container CT to the protocol conversion unit 63. The protocol conversion unit 63 performs protocol conversion for the communication frame FR and then transmits the communication frame FR to the transmission unit 62. The transmission unit 62 transmits the communication frame FR to the communication path 8.

If the packet length is more than the container length (No in S22 and Yes in S25), the communication control circuit 64 divides the data of the packet PK in accordance with the container length (S26). In other words, the communication control circuit 64 divides the packet PK in accordance with the container length.

The communication control circuit 64 inserts the divided data (divided packet data) into separate empty containers CT and transmits them to the lower hierarchy (S27). More specifically, the communication control circuit 64 inserts a packet payload PP including the divided data and its corresponding packet header PH into the container payload CP of each of the empty containers CT. The packet header PH may include information indicating the divided data. In addition, the communication control circuit 64 updates the container header CH of each of the empty containers CT.

The communication control circuit 64 transmits the communication frame FR including the updated container CT to the protocol conversion unit 63. The protocol conversion unit 63 performs protocol conversion for the communication frame FR and then transmits the communication frame FR to the transmission unit 62. The transmission unit 62 transmits the communication frame FR to the communication path 8.

If the packet length and the container length are the same (No in S22 and No in S25), the communication control circuit 64 inserts the data of the packet PK into the empty container CT as one packet payload PP and transmits it to the lower hierarchy (S28).

### 4.2 Specific Example of Integrating Data of Packets and Inserting Integrated data into Container of Communication Frame

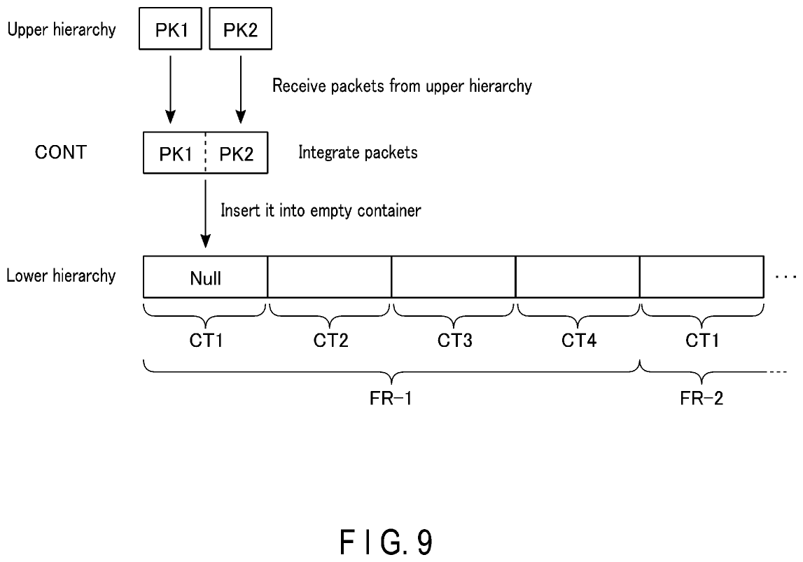

A specific example of integrating data of a plurality of packets PK and then inserting the integrated data into the container CT of the communication frame FR will be described with reference to FIG. 9. FIG. 9 is a diagram showing a specific example of integrating data of a plurality of packets PK and then inserting the integrated data into the container CT of the communication frame FR. In the example of FIG. 9, the communication device 6-1 inserts the integrated data of a plurality of packets PK into the container CT1 of the communication frame FR-1. In FIG. 9, a target container CT (container CT1 of the communication frame FR-1) is shown to simplify the description, and the other containers CT are not shown.

As shown in FIG. 9, the communication control circuit 64 (CONT) of the communication device 6-1 receives data included in the packet PK1 from the upper hierarchy. The communication control circuit 64 compares the packet length and the container length. If the packet length is, for example, ½ times the container length, the communication control circuit 64 further receives data included in a packet PK2 from the upper hierarchy. The communication control circuit 64 integrates data of the packets PK1 and PK2. In other words, the communication control circuit 64 integrates the packets PK1 and PK2.

For example, the container CT1 of the communication frame FR-1 of the lower hierarchy is empty (null). In this case, the communication control circuit 64 inserts a packet payload PP including the integrated data and its corresponding packet header PH into the container payload CP of the container CT1 of the communication frame FR-1. Then, the communication control circuit 64 updates the container header CH.

### 4.3 Specific Example of Dividing Data of Packet and Inserting Divided Data into Containers of Separate Communication Frames

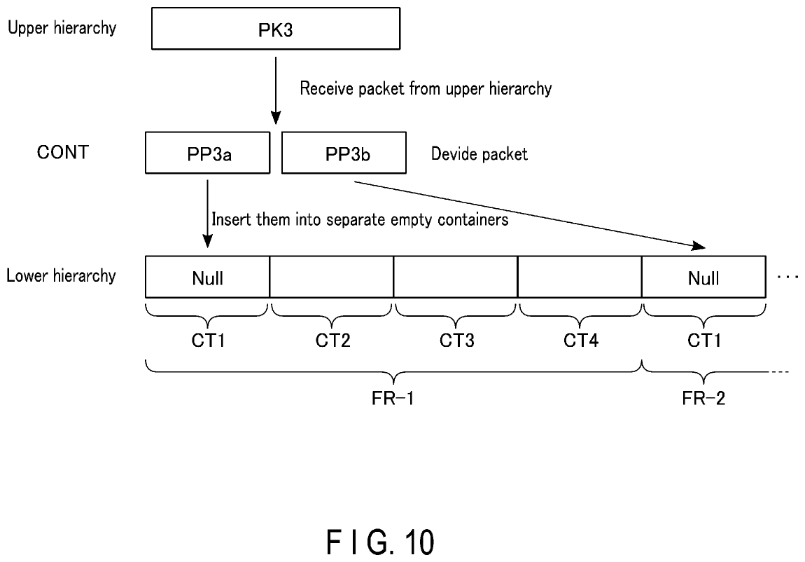

A specific example of dividing data of a packet PK and then inserting the divided data into the containers CT of separate communication frames FR will be described with reference to FIG. 10. FIG. 10 is a diagram showing a specific example of dividing data of a packet PK and then inserting the divided data into the container CT of separate communication frames FR. In the example of FIG. 10, the communication device 6-1 inserts divided data of a packet PK into the container CT1 of the communication frame FR-1 and the container CT1 of the communication frame FR-2. In FIG. 10, target containers CT (the container CT1 of the communication frame FR-1 and the container CT1 of the communication frame FR-2) are shown, and the other containers CT are not shown.

As shown in FIG. 10, the communication control circuit 64 (CONT) of the communication device 6-1 receives data included in a packet PK3 from the upper hierarchy. The communication control circuit 64 compares the packet length and the container length. If the packet length is, for example, two times the container length, the communication control circuit 64 divides the data included in the packet PK3 into two data items. In other words, the communication control circuit 64 divides the packet PK3. The communication control circuit 64 generates a packet payload PP3a including one of the data items and a packet payload PP3b including the other data item.

For example, the container CT1 of the communication frame FR-1 and the container CT1 of the communication frame FR-2 of the lower hierarchy are empty (null). In this case, the communication control circuit 64 inserts the packet payload PP3a and its corresponding packet header PH into the container payload CP of the container CT1 of the communication frame FR-1. In addition, the communication control circuit 64 updates the container header CH of the container CT1 of the communication frame FR-1. Similarly, the communication control circuit 64 inserts the packet payload PP3b and its corresponding packet header PH into the container CT1 of the communication frame FR-2. In addition, the communication control circuit 64 updates the container header CH of the container CT1 of the communication frame FR-2.

### 5. Advantages of Present Embodiment

The configuration according to the present embodiment makes it possible to provide a communication system capable of improving communication processing capability. The advantages of the present embodiment will be described in detail below.

For example, if the container length of a lower hierarchy and the packet length of an upper hierarchy are the same fixed length, the container length and the packet length are set in accordance with a packet having the greatest data length of data necessary for an operation to be performed in the upper hierarchy. For example, if the packet length of a packet corresponding to a write operation is greater than the packet length of a packet corresponding to a read operation, the packet length and the container length are set in accordance with the packet length of the packet corresponding to the write operation. If, therefore, data having a relatively small packet length corresponding to, for example, the read operation, is transmitted from the upper hierarchy to the lower hierarchy, padding data is inserted into an empty area of the container of a communication frame of the lower hierarchy. Thus, the transfer efficiency of data (communication frames) deteriorates. That is, the transfer performance in the communication system deteriorates.

In contrast, with the configuration according to the present embodiment, the packet length of the upper hierarchy of the communication device 6 can be made variable. The communication control circuit 64 of the communication device 6 can divide or integrate the received data. More specifically, when the communication device 6 extracts data from the container CT of the communication frame FR, if the container length is more than the packet length, it can divide the data extracted from the container CT and transmit the divided data to the upper hierarchy. Further, when the communication device 6 extracts data from the container CT of the communication frame FR, if the container length is less than the packet length, it can integrate data of a plurality of containers CT and transmit the integrated data to the upper hierarchy. Furthermore, when the communication device 6 inserts data into the container CT of the communication frame FR, if the container length is more than the packet length, it can integrate the data of the packets PK and insert the integrated data into an empty container CT of the communication frame FR. In addition, when the communication device 6 inserts data into the container CT of the communication frame FR, if the container length is less than the packet length, it can divide data of a packet PK and insert the divided data into a plurality of empty containers CT of the communication frames FR. Thus, the deterioration of transfer efficiency of data (communication frame FR) can be suppressed and so can be the decrease of transfer performance in the communication system.

### 6. Others

Although the foregoing embodiment is directed to the case where the communication device 6 is a memory device including a NAND flash memory, the communication device 6 is not limited to the memory device. A plurality of communication devices 6 mounted on one device card 5 may be different communication devices 6.

Although the foregoing embodiment is also directed to the case where the communication control circuit 64 controls division or integration of data, the host controller 4 may control the data division or data integration. In this case, the host controller 4 may insert information indicating data division or data integration into the packet PK of the communication frame FR. The communication control circuit 64 may divide or integrate data based on the information indicating data division or data integration.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system comprising:
a host controller;
a plurality of communication devices; and
a communication path which couples the host controller and the communication devices in a ring shape and configured to transfer a communication frame of a serial signal,
wherein:
the communication frame includes a plurality of containers;
each of the communication devices includes:
a first circuit configured to insert and extract first data into and from at least one of the containers;
a bus connected to the first circuit; and
a second circuit coupled to the bus and configured to transmit and receive second data corresponding to the first data to and from the first circuit via the bus, and
the first data has a first data length which is a fixed length, and the second data has a second data length which is a unit of transfer of the second data and which is a variable length.

2. The communication system of claim 1, wherein when the first data length of the first data extracted from a first container included in the communication frame is more than the second data length, the first circuit is configured to divide the first data based on the second data length and transmit divided data as the second data to the second circuit via the bus.

3. The communication system of claim 1, wherein when the first data length of the first data extracted from a first container included in the communication frame is less than the second data length, the first circuit is configured to integrate a plurality of first data items from containers, a number of which is based on the second data length, and transmit the integrated data as the second data to the second circuit via the bus.

4. The communication system of claim 1, wherein when the first data length is more than the second data length of the second data received from the second circuit, the first circuit is configured to integrate a plurality of second data items a number of which is based on the first data length and insert the integrated data as the first data into one of the containers.

5. The communication system of claim 4, wherein the first circuit is configured to insert the first data into an empty container of the containers.

6. The communication system of claim 1, wherein when the first data length is less than the second data length of the second data received from the second circuit, the first circuit is configured to divide the second data based on the first data length and insert the divided data as the first data into containers, a number of which is equal to the number of divisions of the second data.

7. The communication system of claim 1, wherein the second data length is based on a protocol of the bus.

8. The communication system of claim 1, wherein the second circuit includes a memory device or a processor.

9. The communication system of claim 8, wherein the memory device includes a NAND flash memory.

10. The communication system of claim 1, wherein each of the containers includes a container payload that stores data to be inserted and extracted and a container header that stores information of a transmission destination of the data to be inserted and extracted and an identifier of the container payload.

11. The communication system of claim 10, wherein the container payload includes a packet payload that stores data to be inserted and extracted and a packet header that stores an identifier of the packet payload.

12. The communication system of claim 1, wherein each of the communication devices further includes:
a reception circuit coupled to the communication path and configured to receive the communication frame from the communication path;
a transmission circuit coupled to the communication path and configured to transmit the communication frame to the communication path; and
a conversion circuit coupled to the reception circuit, the transmission circuit, and the first circuit and configured to perform protocol conversion of the communication frame received from the reception circuit and transmit the communication frame, which is subjected to the protocol conversion, to the first circuit.

13. A communication device comprising:
a reception circuit configured to receive a communication frame of a serial signal including a plurality of containers from a communication path which couples a host controller and a plurality of communication devices in a ring shape;
a first circuit configured to insert and extract first data into and from at least one of the containers;
a bus connected to the first circuit; and
a second circuit coupled to the bus and configured to transmit and receive second data to and from the first circuit via the bus,
wherein the first data has a first data length which is a fixed length, and the second data has a second data length which is a unit of transfer of the second data and which is a variable length.

14. The communication device of claim 13, wherein when the first data length of the first data extracted from a first container included in the communication frame is more than the second data length, the first circuit is configured to divide the first data based on the second data length and transmit the divided data as the second data to the second circuit via the bus.

15. The communication device of claim 13, wherein when the first data length of the first data extracted from a first container included in the communication frame is less than the second data length, the first circuit is configured to integrate a plurality of first data items from containers, a number of which is based on the second data length, and transmit the integrated data as the second data to the second circuit via the bus.

16. The communication device of claim 13, wherein when the first data length is more than the second data length of the second data received from the second circuit, the first circuit is configured to integrate a plurality of second data items a number of which is based on the first data length and insert the integrated data as the first data into one of the containers.

17. The communication device of claim 13, wherein when the first data length is less than the second data length of the second data received from the second circuit, the first circuit is configured to divide the second data based on the first data length and insert the divided data as the first data into containers, a number of which is equal to the number of divisions of the second data.

18. A communication method in a communication system including a host controller, a plurality of communication devices, and a communication path, each communication device including a first circuit, a second circuit, and a bus coupling the first circuit and the second circuit, the communication path coupling the host controller and the communication devices in a ring shape and configured to transfer a communication frame of a serial signal including a plurality of containers, the method comprising:
transmitting a communication frame to the communication path from the host controller or one of the communication devices;
inserting and extracting first data of a fixed length into and from at least one of the containers in the first circuit of a communication device that received the communication frame; and
transmitting and receiving second data of a variable length corresponding to the first data to and from the second circuit via the bus in the communication device that received the communication frame.

19. The communication method of claim 18, wherein the transmitting and receiving comprises:
causing the first circuit to divide the first data based on a second data length of the second data and transmit the divided data as the second data to the second circuit via the bus when a first data length of the first data extracted from a first container included in the communication frame is more than the second data length; and
causing the first circuit to integrate a plurality of first data items from containers, a number of which is based on the second data length, and transmit the integrated data as the second data to the second circuit via the bus when the first data length is less than the second data length.

20. The communication method of claim 18, wherein the inserting and extracting comprises:
causing the first circuit to integrate a plurality of second data items based on a first data length of the first data and insert the integrated data as the first data into one of the containers when the first data length is more than a second data length of the second data received from the second circuit; and
causing the first circuit to divide the second data based on the first data length and insert the divided data as the first data into containers, a number of which is equal to the number of divisions of the second data, when the first data length is less than the second data length.
